(19) United States
(12) Patent Application Publication
(10) Pub. No.: US 2016/0070713 A1
(43) Pub. Date: Mar. 10, 2016

(54) DEVICE-CENTRIC MEDIA PRIORITIZATION SYSTEMS AND METHODS

(71) Applicant: RealNetworks, Inc., Seattle, WA (US)

(72) Inventor: Milko BOIC, Sammamish, WA (US)

(21) Appl. No.: 14/480,497

(22) Filed: Sep. 8, 2014

(51) Int. Cl. G06F 17/30

(52) U.S. Cl. CPC G06F 17/30141; G06F 17/30017

(57) ABSTRACT

In a system comprising media files resident on various devices which can interconnect and provide indices of their media library content, an organization method may provide an aggregate view of the media library of all connected devices ordering the media library contents of various connected devices from the point of view of the device from which the view of the aggregate library will be shown. This point-of-access-centric view of the library is formed by prioritizing significance or permanency or remoteness of the connected devices from the perspective of the viewing device. The content sort order is then boosted based on the device's priority.

### CROSS-REFERENCE TO RELATED APPLICATIONS

This application claims the benefit of priority to Provisional Patent Application No. 61/874,923; filed Sep. 6, 2013 under Attorney Docket No. REAL-2013419 (RN438p); titled MULTI-DEVICE DISTRIBUTED MEDIA LIBRARY ORGANIZATION SYSTEMS AND METHODS; and naming inventor Milko BOIC. The above-cited application is hereby incorporated by reference, in its entirety, for all purposes.

### FIELD

This disclosure is directed to the field of software, and more particularly to prioritizing a piece of media content with respect to other pieces of media content in a distributed-media-library system from a perspective of a viewing device.

### BACKGROUND

Various media systems allow different devices to share locally-hosted media files with other devices connected via a network. A user may desire to view an aggregated view of media content that is available across various devices within such a media-sharing group. Existing methods of sorting, presenting, and/or indexing aggregated media content may allow a user to sort or organize a view of an aggregated media library according to various factors, such as by file creation and/or modification date. However, in an aggregated media library, organizing media content according to such factors may fail to promote remote and/or aggregated content from the perspective of the viewing device.

### BRIEF DESCRIPTION OF THE DRAWINGS

FIG. 1 illustrates a simplified device-centric media prioritization system in which several distributed-media client/server devices and cloud-based media storage are connected to network.

FIG. 2 illustrates a routine for presenting pieces of media content in a distributed-media-library system from the perspective of a given viewing device, such as may be performed by a distributed-media client/server device in accordance with one embodiment.

FIG. 3 illustrates a sort-key subroutine for prioritizing a given piece of media content from the perspective of a given viewing device, such as may be performed by a distributed-media client/server device in accordance with one embodiment.

FIG. 4 illustrates several components of an exemplary distributed-media client/server device in accordance with one embodiment.

### DESCRIPTION

The phrases “in one embodiment”, “in various embodiments”, “in some embodiments”, and the like are used repeatedly. Such phrases do not necessarily refer to the same embodiment. The terms “comprising”, “having”, and “including” are synonymous, unless the context dictates otherwise.

A distributed-media-library system typically includes many pieces of media content distributed across a number of different devices, clouds, and/or other media repositories that are all associated with a given user. As the term is used herein, a “piece of media content” refers to particular audio and/or video content that may exist in multiple forms within the distributed-media-library system. For example, a particular audio track from a particular CD may be a piece of media content that corresponds to an uncompressed “.wav” media file and that also corresponds to a compressed “.mp3” file. The uncompressed file and the compressed media file are considered to be different versions of the same piece of media content (the particular track).

Other examples of distinct pieces of media content include a particular episode of a particular TV show, a particular image captured by a particular capture device, and a particular video and/or sound recording made by a particular capture device. Each of such pieces of media content could exist in multiple versions (e.g., in different container formats, in different resolutions, in different codecs, and the like) in multiple media files. But all such derivative media files are considered to correspond to the same piece of media content.

As discussed above, the distributed-media-library system may include several media files that are all different versions a given piece of media content. Such media files often are copied from device to device within the distributed-media-library system, and it is common for the distributed-media-library system to include several versions and/or copies of the given piece of media content. Frequently, the different versions and/or copies of the given piece of media content may have been introduced to different media-library devices at different dates and/or times. For example, one version or copy of the given piece of media content may have resided on media-library device “A” for months or years, while another version or copy of the given piece of media content may have been introduced to media-library device “B” only recently.

When the user views content in the distributed-media-library system from a given viewing device, relevant and/or recent content may be prioritized. The relevance and/or recency are determined from a device-centric point of view, such that pieces of media content that are recently introduced and/or otherwise relevant to the given viewing device takes precedence over piece of media content that may be recently introduced and/or otherwise relevant to other of the user's devices that may be less closely associated with the given viewing device.

Different media-library devices that all store a copy and/or version of the given piece of media content may be prioritized according to how closely they are associated with the given viewing device. For example, in one embodiment, the given viewing device itself may be prioritized highly, as may a “cloud” media-repository that is always or nearly always available to the given viewing device, such that it can be treated as a very close extension of the given viewing device. Other of the user's media-library devices that are always or nearly always on and that frequently communicate with the given viewing device may be given a secondary priority (e.g., a media PC may be given a secondary priority with respect to a mobile phone, tablet, or other mobile media-viewing device). Other of the user's media-library devices and/or storage repositories that either do not typically store a lot of media content or that do not frequently communicate with the given viewing device may be given a tertiary priority (e.g., a user's tablet may be given a tertiary priority with respect to the user's mobile phone).

When presented on the given viewing device among other pieces of media content in the distributed-media-library system, the given piece of media content may be sorted according to its introduction date and/or time on a highly prioritized media-library device, where the prioritization is determined from the a perspective of a viewing device, as discussed above. As a result, the given piece of media content may be assume a different sorted position among other content in the user's distributed media library when that library is viewed from different devices.

If two or more media-library devices all have copies and/or versions of the given piece of media content, and all have the same and/or very similar priorities with respect to the given viewing device, then either an earliest or a latest introduction date and/or time may be determined among the members of that priority group. Selecting an earliest introduction date and/or time may promote stability within media content listings, as moving a piece of media content among members of a priority group will not affect the sorted position of the piece of media content in listings when viewed from a viewing device that is closely associated with members of the group. By contrast, selecting a latest introduction date and/or time will cause the sorted position of the piece of media content to be promoted when the piece of media content is moved among members of the group and viewed from a closely-associated viewing device.

More particularly, as discussed herein, in various embodiments, a processor and/or processing device may be configured (e.g., via non-transitory computer-readable storage media) to perform a first method for prioritizing a piece of media content with respect to other pieces of media content in a distributed-media-library system from a perspective of a viewing device, the first method including steps similar to some or all of the following:
identifying a plurality of media-library devices that collectively store a plurality of media files, each of which comprises a version of the piece of media content, at least some of which are associated with differing sort metadata;
determining a plurality of priority metrics corresponding respectively to the plurality of media-library devices, each priority metric measuring an association between one of the plurality of media-library devices and the viewing device;
selecting, according to the plurality of priority metrics, a media-library device that is closely-associated with the viewing device, the closely-associated media-library device storing a selected media file of the plurality of media files;
determining, based on the sort metadata associated with the selected media file, a viewing-device-centric sort key for the piece of media content;
sorting the piece of media content according to the viewing-device-centric sort key with respect to the other pieces of media content when the piece of media content is viewed from the perspective of the viewing device; and/or
sorting the piece of media content according to a second viewing-device-centric sort key with respect to the other pieces of media content when the piece of media content is viewed from a perspective of a second viewing device.

In some cases, the viewing-device-centric sort key may include a date and/or time at which the selected media file was introduced onto the closely-associated media-library device, or the like.

In some cases, selecting the closely-associated media-library device may include steps similar to some or all of the following:
selecting a priority group comprising at least two of the plurality of media-library devices that are equally closely associated with the viewing device;
identifying at least two of the plurality of media files as being stored respectively by the priority group; and
selecting the closely-associated media-library device from among the priority group based on sort metadata associated with the at least two of the plurality of media files, or the like.

In some cases, selecting the closely-associated media-library device from among the priority group may include steps similar to some or all of the following:
selecting the closely-associated media-library device onto which one of the plurality of media files was introduced more recently than others of the priority group; and/or
selecting the closely-associated media-library device onto which one of the plurality of media files was introduced less recently than others of the priority group.

In some cases, each priority metric measures a period of time since the viewing device and one of the plurality of media-library devices were connected to one another.

In some cases, the closely-associated media-library device is the viewing device.

Described more fully below are many additional details, variations, and embodiments that may or may not include some or all of the steps, features, and/or functionality described above.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

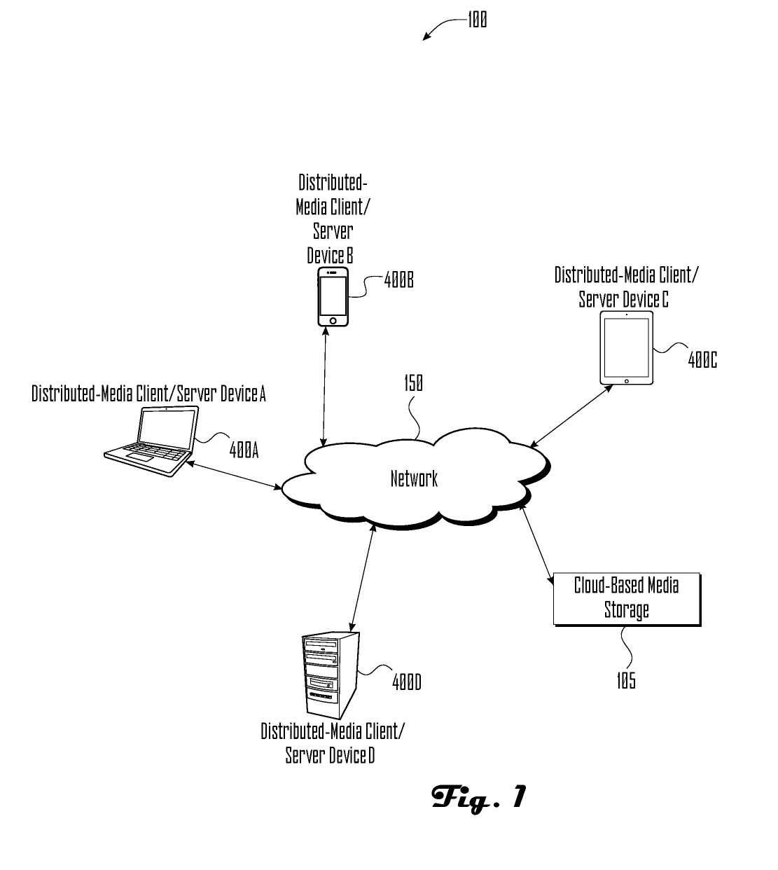

FIG. 1 illustrates a simplified device-centric media prioritization system in which several distributed-media client/server devices 400A-D and cloud-based media storage 105 are connected to network 150.

In various embodiments, network 150 may include the Internet, a local area network (“LAN”), a wide area network (“WAN”), and/or other data network.

In various embodiments, additional infrastructure (e.g., cell sites, routers, gateways, firewalls, and the like), as well as additional devices may be present. However, it is not necessary to show such infrastructure and implementation details in FIG. 1 in order to describe an illustrative embodiment.

In an exemplary scenario, media files may be resident on various interconnected devices (such as distributed-media client/server devices 400A-D) and storage facilities (such as cloud-based media storage 105) that share media library content. At least some of the devices may include media scanners, media clients, and/or media servers. The devices themselves can interconnect via media servers and media clients resident thereon.

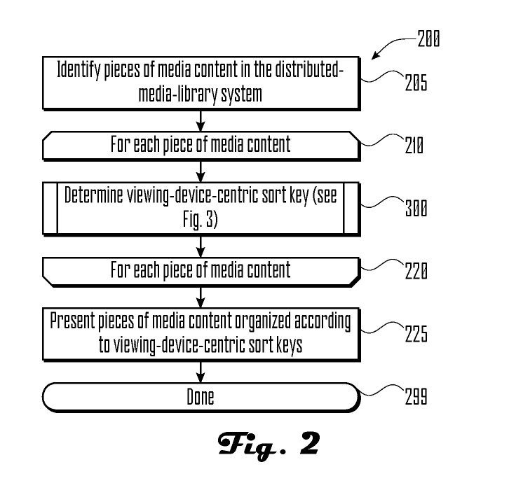

FIG. 2 illustrates a routine 200 for presenting pieces of media content in a distributed-media-library system from the perspective of a given viewing device, such as may be performed by a distributed-media client/server device 400 in accordance with one embodiment.

In block 205, routine 200 identifies one or more pieces of media content that are available in the distributed-media-library system, e.g., from a local datastore, such as local media datastore 440, and from one or more remote distributed-media client/server devices.

Beginning in opening loop block 210, routine 200 processes each piece of media content in turn.

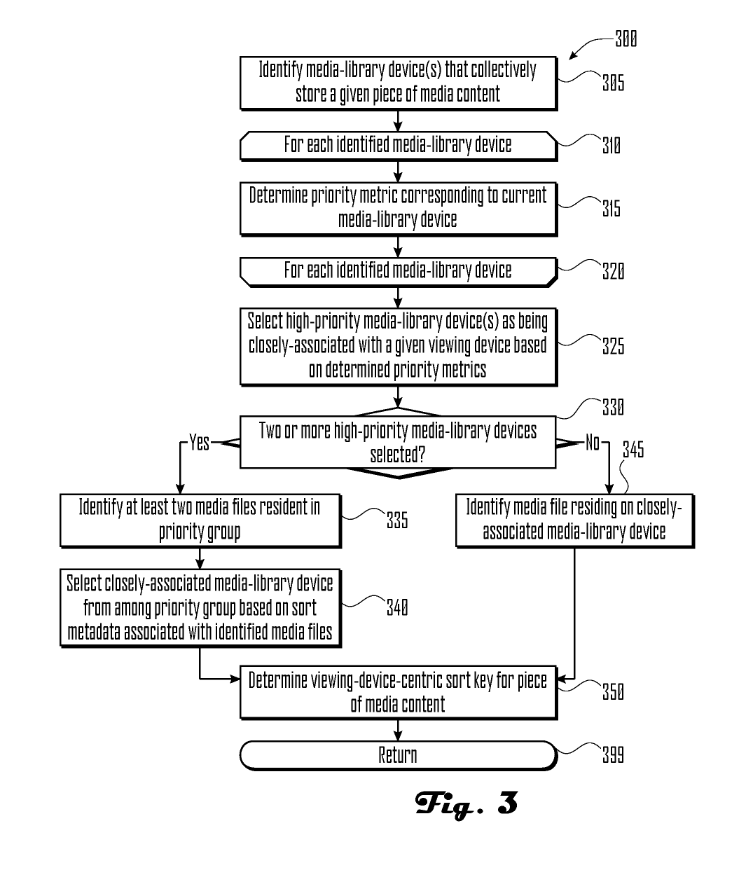

In subroutine block 300, routine 200 calls subroutine 300 (see FIG. 3, discussed below) to determine a viewing-device-centric sort key to prioritize the current piece of media content with respect to other pieces of media content in the distributed-media-library system.

In ending loop block 220, routine 200 iterates back to opening loop block 210 to process the next piece of media content, if any.

Once each piece of media content has been prioritized, in block 225, routine 200 sorts and presents the pieces of media content according to the determined viewing-device-centric sort keys when viewed from the perspective of the given viewing device.

Routine 200 ends in ending block 299.

FIG. 3 illustrates a sort-key subroutine 300 for prioritizing a given piece of media content from the perspective of a given viewing device, such as may be performed by a distributed-media client/server device 400 in accordance with one embodiment.

In block 305, sort-key subroutine 300 identifies one or more media-library devices that collectively store one or more media files that are versions and/or copies of the given piece of media content. Typically, at least some of of the different media files are associated with differing sort metadata. For example, in one embodiment, the sort metadata may indicate a date and/or time at which a media file corresponding to the given piece of media content was copied to, stored on, or otherwise introduced to a media-library device. In other embodiments, the sort metadata may indicate a date and/or time at which a media file corresponding to the given piece of media content was played, viewed, edited, and/or otherwise interacted with by a user.

Beginning in opening loop block 310, sort-key subroutine 300 processes each identified media-library device in turn.

In block 315, sort-key subroutine 300 determines a priority metric corresponding to the current identified media-library device. The priority metric measures an association between the current identified media-library device and the given viewing device. In some embodiments, the priority metric measures a period of time since the given viewing device and the current identified media-library device were connected to one another.

For example, in one embodiment, if the given viewing device is a mobile device that was recently connected to a desktop/laptop media PC, then the media PC may be given a high priority metric based on the recency of the connection. Similarly, if the given viewing device recently connected to a cloud-based media repository (e.g., cloud-based media storage 105), then the cloud-based media repository may be given a high priority metric. Conversely, a media-library device that has not recently communicated with and/or been connected to the given viewing device may be given a low priority metric.

In ending loop block 320, sort-key subroutine 300 iterates back to opening loop block 310 to process the next identified media-library device, if any.

In block 325, sort-key subroutine 300 selects one or more high-priority media-library device(s) as being closely-associated with a given viewing device based on the determined priority metrics. In some embodiments, one of the selected devices may be the given viewing device itself.

In some embodiments, if two or more media-library devices have the same and/or very similar priority metrics, then in block 325, sort-key subroutine 300 may select a priority group comprising at least two of media-library devices that are equally closely associated with viewing device.

In decision block 330, sort-key subroutine 300 determines whether two or more high-priority media-library devices were selected in block 325. If so, sort-key subroutine 300 proceeds to block 335; otherwise, sort-key subroutine 300 proceeds to block 345.

In block 335, sort-key subroutine 300 identifies two or more media files that correspond to the given piece of media content and that are stored on the two or more media-library devices of the priority group selected in block 325.

In block 340, sort-key subroutine 300 selects a closely-associated media-library device from among those in the priority group based on sort metadata associated with the media files identified in block 335.

For example, in one embodiment, sort-key subroutine 300 selects a media-library device because one of the media files (identified in block 335) was introduced onto that media-library device more recently than others of the media files (selected in block 335) were introduced onto others of the priority group.

In other embodiments, sort-key subroutine 300 selects a media-library device because one of the media files (identified in block 335) was introduced onto that media-library device less recently than others of the media files (selected in block 335) were introduced onto others of the priority group.

Selecting an earlier (less recent) introduction date and/or time may promote stability within media content listings, as moving the given piece of media content among members of a priority group will not affect the sorted position of the given piece of media content in listings when viewed from a viewing device that is closely associated with members of the group. By contrast, selecting a latest (more recent) introduction date and/or time will cause the sorted position of the given piece of media content to be promoted when the given piece of media content is moved among members of the group and viewed from a closely-associated viewing device.

In block 345, sort-key subroutine 300 identifies a media file that corresponds to the given piece of media content and that is stored on the media-library device selected in block 325.

In block 350, sort-key subroutine 300 determines, based on the sort metadata associated with the media file selected in block 340 or block 345, a viewing-device-centric sort key for the given piece of media content. In some embodiments, the viewing-device-centric sort key may comprise a date and/or time at which the selected media file was introduced onto the closely-associated media-library device.

Sort-key subroutine 300 ends in ending block 399, returning the viewing-device-centric sort key determined in block 350 to the caller.

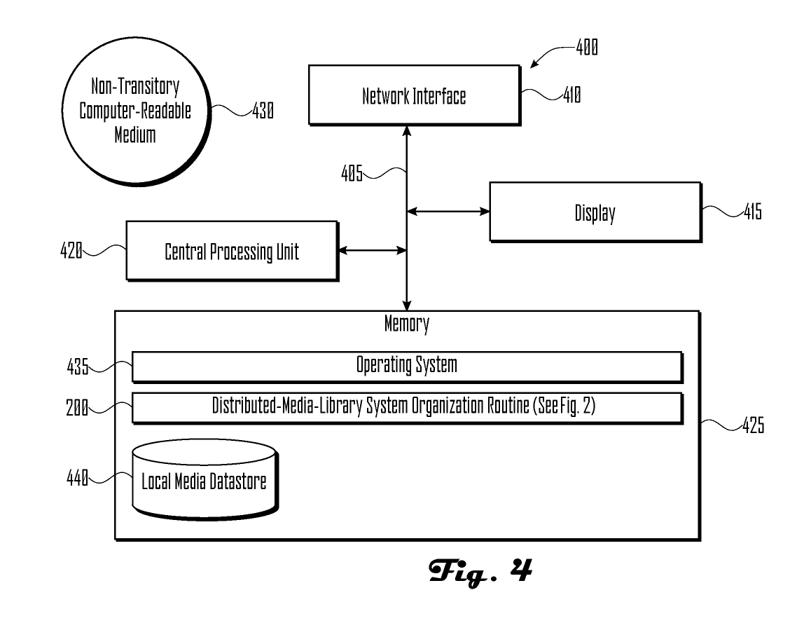

FIG. 4 illustrates several components of an exemplary distributed-media client/server device in accordance with one embodiment. In various embodiments, distributed-media client/server device 400 may include a desktop PC, server, workstation, mobile phone, laptop, tablet, set-top box, appliance, or other computing device that is capable of performing operations such as those described herein. In some embodiments, distributed-media client/server device 400 may include many more components than those shown in FIG. 4. However, it is not necessary that all of these generally conventional components be shown in order to disclose an illustrative embodiment.

In various embodiments, distributed-media client/server device 400 may comprise one or more physical and/or logical devices that collectively provide the functionalities described herein. In some embodiments, distributed-media client/server device 400 may comprise one or more replicated and/or distributed physical or logical devices.

In some embodiments, distributed-media client/server device 400 may comprise one or more computing resources provisioned from a “cloud computing” provider, for example, Amazon Elastic Compute Cloud (“Amazon EC2”), provided by Amazon.com, Inc. of Seattle, Wash.; Sun Cloud Compute Utility, provided by Sun Microsystems, Inc. of Santa Clara, Calif.; Windows Azure, provided by Microsoft Corporation of Redmond, Wash., and the like.

Distributed-media client/server device 400 includes a bus 405 interconnecting several components including a network interface 410, a display 415, a central processing unit 420, and a memory 425.

Memory 425 generally comprises a random access memory (“RAM”) and permanent non-transitory mass storage device, such as a hard disk drive or solid-state drive. Memory 425 stores program code for a routine 200 for presenting pieces of media content in a distributed-media-library system from the perspective of a given viewing device (see FIG. 2, discussed above). In addition, the memory 425 also stores an operating system 435.

These and other software components may be loaded into memory 425 of distributed-media client/server device 400 using a drive mechanism (not shown) associated with a non-transitory computer-readable medium 430, such as a floppy disc, tape, DVD/CD-ROM drive, memory card, or the like.

Memory 425 also includes local media datastore 440. In some embodiments, distributed-media client/server device 400 may communicate with local media datastore 440 via network interface 410, a storage area network (“SAN”), a high-speed serial bus, and/or via the other suitable communication technology.

Although specific embodiments have been illustrated and described herein, it will be appreciated by those of ordinary skill in the art that alternate and/or equivalent implementations may be substituted for the specific embodiments shown and described without departing from the scope of the present disclosure. This application is intended to cover any adaptations or variations of the embodiments discussed herein.

1. A computer-implemented method for prioritizing a piece of media content with respect to other pieces of media content in a distributed-media-library system from a perspective of a viewing device, the method comprising:
identifying a plurality of media-library devices that collectively store a plurality of media files, each of which comprises a version of the piece of media content, at least some of which are associated with differing sort metadata;
determining a plurality of priority metrics corresponding respectively to the plurality of media-library devices, each priority metric measuring an association between one of the plurality of media-library devices and the viewing device;
selecting, according to the plurality of priority metrics, a media-library device that is closely-associated with the viewing device, the closely-associated media-library device storing a selected media file of the plurality of media files;
determining, based on the sort metadata associated with the selected media file, a viewing-device-centric sort key for the piece of media content; and
sorting the piece of media content according to the viewing-device-centric sort key with respect to the other pieces of media content when the piece of media content is viewed from the perspective of the viewing device.

2. The method of claim 1, wherein the viewing-device-centric sort key comprises a date and/or time at which the selected media file was introduced onto the closely- associated media-library device.

3. The method of claim 1, wherein each priority metric measures a period of time since the viewing device and one of the plurality of media-library devices were connected to one another.

4. The method of claim 1, wherein selecting the closely-associated media-library device comprises:
selecting a priority group comprising at least two of the plurality of media-library devices that are equally closely associated with the viewing device;
identifying at least two of the plurality of media files as being stored respectively by the priority group; and
selecting the closely-associated media-library device from among the priority group based on sort metadata associated with the at least two of the plurality of media files.

5. The method of claim 4, wherein selecting the closely-associated media-library device from among the priority group comprises selecting the closely-associated media-library device onto which one of the plurality of media files was introduced more recently than others of the priority group.

6. The method of claim 4, wherein selecting the closely-associated media-library device from among the priority group comprises selecting the closely-associated media-library device onto which one of the plurality of media files was introduced less recently than others of the priority group.

7. The method of claim 1, wherein the closely-associated media-library device is the viewing device.

8. The method of claim 1, further comprising sorting the piece of media content according to a second viewing-device-centric sort key with respect to the other pieces of media content when the piece of media content is viewed from a perspective of a second viewing device.

9. A computing apparatus for prioritizing a piece of media content with respect to other pieces of media content in a distributed-media-library system from a perspective of a viewing device, the apparatus comprising a processor and a memory storing instructions that, when executed by the processor, configure the apparatus to:
identify a plurality of media-library devices that collectively store a plurality of media files, each of which comprises a version of the piece of media content, at least some of which are associated with differing sort metadata;
determine a plurality of priority metrics corresponding respectively to the plurality of media-library devices, each priority metric measuring an association between one of the plurality of media-library devices and the viewing device;
select, according to the plurality of priority metrics, a media-library device that is closely-associated with the viewing device, the closely-associated media-library device storing a selected media file of the plurality of media files;
determine, based on the sort metadata associated with the selected media file, a viewing-device-centric sort key for the piece of media content; and
sort the piece of media content according to the viewing-device-centric sort key with respect to the other pieces of media content when the piece of media content is viewed from the perspective of the viewing device.

10. The apparatus of claim 9, wherein the instructions that configure the apparatus to the viewing-device-centric sort key further comprise instructions configuring the apparatus to a date and/or time at which the selected media file was introduced onto the closely-associated media-library device.

11. The apparatus of claim 9, wherein each priority metric measures a period of time since the viewing device and one of the plurality of media-library devices were connected to one another.

12. The apparatus of claim 9, wherein the instructions that configure the apparatus to select the closely-associated media-library device further comprise instructions configuring the apparatus to:
select a priority group comprising at least two of the plurality of media-library devices that are equally closely associated with the viewing device;
identify at least two of the plurality of media files as being stored respectively by the priority group; and
select the closely-associated media-library device from among the priority group based on sort metadata associated with the at least two of the plurality of media files.

13. The apparatus of claim 12, wherein the instructions that configure the apparatus to select the closely-associated media-library device from among the priority group further comprise instructions configuring the apparatus to select the closely-associated media-library device onto which one of the plurality of media files was introduced more recently than others of the priority group.

14. The apparatus of claim 12, wherein the instructions that configure the apparatus to select the closely-associated media-library device from among the priority group further comprise instructions configuring the apparatus to select the closely-associated media-library device onto which one of the plurality of media files was introduced less recently than others of the priority group.

15. A non-transitory computer-readable storage medium having stored thereon instructions including instructions that, when executed by a processor, configure the processor to:
identify a plurality of media-library devices that collectively store a plurality of media files, each of which comprises a version of a piece of media content, at least some of which are associated with differing sort metadata;
determine a plurality of priority metrics corresponding respectively to the plurality of media-library devices, each priority metric measuring an association between one of the plurality of media-library devices and a viewing device;
select, according to the plurality of priority metrics, a media-library device that is closely-associated with the viewing device, the closely-associated media-library device storing a selected media file of the plurality of media files;
determine, based on the sort metadata associated with the selected media file, a viewing-device-centric sort key for the piece of media content; and
sort the piece of media content according to the viewing-device-centric sort key with respect to other pieces of media content when the piece of media content is viewed from a perspective of the viewing device.

16. The non-transitory computer-readable storage medium of claim 15, wherein the instructions that configure the processor to the viewing-device-centric sort key further comprise instructions configuring the processor to a date and/or time at which the selected media file was introduced onto the closely-associated media-library device.

17. The non-transitory computer-readable storage medium of claim 15, wherein each priority metric measures a period of time since the viewing device and one of the plurality of media-library devices were connected to one another.

18. The non-transitory computer-readable storage medium of claim 15, wherein the instructions that configure the processor to select the closely-associated media-library device further comprise instructions configuring the processor to:
select a priority group comprising at least two of the plurality of media-library devices that are equally closely associated with the viewing device;
identify at least two of the plurality of media files as being stored respectively by the priority group; and
select the closely-associated media-library device from among the priority group based on sort metadata associated with the at least two of the plurality of media files.

19. The non-transitory computer-readable storage medium of claim 18, wherein the instructions that configure the processor to select the closely-associated media-library device from among the priority group further comprise instructions configuring the processor to select the closely-associated media-library device onto which one of the plurality of media files was introduced more recently than others of the priority group.

20. The non-transitory computer-readable storage medium of claim 18, wherein the instructions that configure the processor to select the closely-associated media-library device from among the priority group further comprise instructions configuring the processor to select the closely-associated media-library device onto which one of the plurality of media files was introduced less recently than others of the priority group.
